(19) United States
(12) Patent Application Publication
(10) Pub. No.: US 2009/0260754 A1
(43) Pub. Date: Oct. 22, 2009

(54) CASTING RESIN FOR ADHESIVE BONDING OF FIBERS

(76) Inventor: ANDRE TE POEL, Willich (DE)

Correspondence Address: Henkel Corporation, 10 Finderne Avenue, Bridgewater, NJ, 08807, US

(21) Appl. No.: 12/430,955

(22) Filed: Apr. 28, 2009

Related U.S. Application Data
(63) Continuation of application No. PCT/EP2007/059637, filed on Sep. 13, 2007.

(30) Foreign Application Priority Data
Oct. 30, 2006 (DE) 10 2006 051 726.1

(51) Int. Cl. B32B 37/02; C08L 75/04; B32B 37/12

(52) U.S. Cl. 156/245; 525/453; 156/331.7

(57) ABSTRACT

The invention relates to a liquid 2K polyurethane composition of a polyol component A comprising at least one hydrophobic polyol with a molecular weight>300 g/mol and a hydrophilic polyol with a molecular weight<500 g/mol, and 1 to 50 wt. % of a powdered molecular sieve as well as a polyisocyanate or an NCO-reactive PU-prepolymer. In addition, a process is described for casting plastic or metallic moldings, particularly membrane substrates, by the use of an inventive 2K polyurethane composition.

### CROSS-REFERENCE TO RELATED APPLICATIONS

This application is a continuation of PCT/EP2007/059637 filed Sep. 13, 2007, which claims the benefit of DE 10 2006 051 726.1 filed Oct. 30, 2006, the complete disclosures of which are hereby incorporated by reference in their entirety.

### FIELD OF THE INVENTION

The invention relates to a 2K polyurethane composition that is suitable for adhesively bonding membranes, for example hollow fibers. In addition, a process is described for adhesively bonding moist hollow fibers with 2K polyurethane compositions.

### BACKGROUND OF THE INVENTION

Casting resins are known in various fields of industry. They can be one or two component compounds that are applied in the liquid state and subsequently crosslink to a solid compound at room temperature or on heating. Various parts, for example metallic, plastic or of natural origin can be embedded in molded articles of this type.

Casting resins of this type based on two-component amino-epoxy resins are known. These types of amino-epoxy resins have very good properties in regard to stability; they have the disadvantage, however, that the reaction is strongly exothermic. On crosslinking thicker layers or thicker molded articles, the reaction yields high temperatures. This can result in parts to be embedded being destroyed by the heat, losing their shape, or that the amino-epoxy resins take on a dark color. Consequently, these amino-epoxy resins are unsuitable for many applications.

Polyurethane potting compounds are also known that are suitable for use in medical articles. Transparent sterilizable polyurethane potting compounds are described in EP 0 413 265. They consist of modified MDI components together with a compound that comprises at least two reactive hydrogen atoms. Polyols based on polyesters or polyethers containing ethylene oxide units are examples of these. Catalysts can also be comprised. A use of powdered additives such as fillers or pigments is not described. PU casting resins of this type are employed for potting hollow fibers based on polysulfone.

In addition, U.S. Pat. No. 4,170,559 is known. This describes a crosslinkable polyurethane prepolymer that can be crosslinked by polyhydric alcohols containing two or three OH groups. Castor oil can also be comprised in the crosslinking components. The use of specific pigments or fillers is not described. The 2K PU casting resin is employed for potting hollow fibers.

In addition, U.S. Pat. No. 4,877,829 is known. In this document, polyurethane adhesives are described, which are suitable for adhesively bonding concrete. In this way an impermeable membrane is glued onto a concrete surface. The adhesive additionally comprises an elastomeric component such as natural or synthetic rubber.

The casting resins based on 2K polyurethane binders described above have the disadvantage that an exact NCO:OH ratio has to be respected. This is the only way that an adequate crosslinking can be ensured. If too great a quantity of isocyanate is employed then this can lead to side reactions, for example bubble formation is observed.

Another disadvantage of the casting resins described above consists in that they must be stored and applied under dry conditions. In the presence of catalysts, polyisocyanates react easily with water, for example atmospheric humidity, which then leads to a premature gelling. Urea bonds are formed or bubbles can be produced. Side reactions of this type often occur when the materials to be adhesively bonded have not been dried.

When adhesively bonding fibers or membranes, which are processed directly after a manufacturing process, these are often wetted with water. Porous materials having a large surface area can comprise a high amount of surface moisture. Other polar solvents can also be comprised, such as mono-alcohols, diols, triols or other compounds containing H-acidic groups, for example amino-containing or carboxyl-containing compounds. This in turn means that isocyanate-crosslinking binders are not suitable for adhesively bonding moist membrane parts. An adequate crosslinking is not ensured due to the high water contents that in addition are also difficult to uniformly adjust. Moreover, side reactions can in turn produce bubbles and cavities, and a uniform crosslinking through the whole compound cannot be assured. By washing and drying, it is known to manufacture membrane surfaces that possess only little or no residual moisture. However, this process technology is very laborious.

### SUMMARY OF THE INVENTION

Consequently, the object of the present invention is to provide a 2K polyurethane composition that does not possess the disadvantages of the casting resins mentioned above. Thus, the individual components should be provided with adequate moisture stability. In addition, it should be ensured that even damp substrates can be adhesively bonded. Another object of the invention is to provide adhesively bonded moldings of membrane bodies and 2K polyurethane compositions, which even under long-term exposure to water, increased pressure or sterilization conditions, allow a stable adhesive bond with various substrates.

The object is achieved in that a crosslinkable, liquid 2K polyurethane composition is made available consisting of a component A that comprises a mixture of at least one hydrophobic polyol with a molecular weight greater than 300 g/mol and at least one low molecular weight hydrophilic polyol with a molecular weight lower than 500 g/mol, and a component B comprising at least one polyisocyanate and/or an NCO-reactive PU prepolymer, wherein the component A comprises 1 to 50 wt. %, based on the component A, of powdered molecular sieves. Another subject matter of the invention is a process for adhesively bonding plastic substrates, especially membrane substrates, with a 2K PU composition. Another subject matter of the invention concerns molded articles of membrane substrates that are adhesively bonded with an inventive 2K PU composition.

### DETAILED DESCRIPTION OF THE INVENTION

In the context of this invention, suitable 2K PU compositions are liquid, at least at the temperature of application. They are preferably exempt from volatile organic solvents. Such compounds can be employed as an adhesive, as a potting compound or casting resin. After crosslinking, these types of 2K PU compounds form solid, dimensionally stable bodies that are no longer tacky on the surface.

An inventive 2K PU composition can be cast or adhered onto a wide variety of substrates. It is possible, for example to adhesively bond together metallic substrates such as wires, sheets, films or other molded parts. It is also possible to adhesively bond plastic parts of various shapes. They can be plates, fibers, hollow fibers or films, for example. Moreover, natural or synthetic fibers can also be adhesively bonded. In particular, it is possible to cast inventive compositions on the exterior of hollow objects and thus bond together various plastic parts and/or metallic parts into one molded article. In this case, the liquid composition should flow into the cavity between the parts at the point of adhesion.

The inventive 2K PU compositions are particularly suitable for adhesively bonding membranes of synthetic or natural polymers. Here, this concerns flat structures or hollow fibers, wherein the fiber wall is formed from polymers that can assume the function of a membrane. The materials of membranes of this type are known. Examples of these are polybenzimidazoles, polyoxadiazoles, polyimides, polyether imides, sulfonated or chloromethylated polyether sulfones, polycarbonates, polyphenylene oxide or polydimethylsiloxanes. They can also be natural raw materials such as cellulose acetate, ethyl cellulose or other cellulose derivatives. Polymers for the manufacture of such membranes are described, for example in Chemie-Ingenieurtechnik 2005, 77, no. 5, pp 487 ff. Processes for manufacturing such membranes or hollow fiber membranes are also known, for example from WO 2005/082502.

Another group of substrates that can be adhesively bonded with the inventive compositions are fibers. Natural materials or synthetic materials can be employed as the fibers. Examples of such materials are cellulose fibers, wood fibers, silk, linen, sisal, hemp; exemplary synthetic fibers are fibers of polyethylene, polypropylene, glass fibers, carbon fibers or Aramid fibers. The diameter of these fibers can range between a few μm and 1 mm. The length of the fibers is not important; one has only to ensure that the fibers can be sufficiently solidly embedded on at least one side into the adhesive matrix.

The inventive 2K PU composition consists of a polyol component A and an isocyanate component B. Component A must comprise at least one hydrophobic polyol. Hydrophobic polyols are understood to mean those polyols that are hardly miscible or immiscible with water. The polyols should possess a plurality of OH groups, for example between 2 and 20, especially between 2 and 10. Exemplary hydrophobic polyols are oleochemical polyols, OH group-containing polybutadienes or polyethers based on C3 and/or C4 alkylene oxides. The molecular weight of the hydrophobic polyols should generally be between 300 g/mol and 15 000 g/mol, especially greater than 500 g/mol to 10 000 g/mol (number average molecular weight as can be determined by GPC).

The OH group-containing polybutadienes are understood to mean oligomers or polymers of butadiene, which in addition to the optionally still present double bonds, possess at least two OH groups. These may be terminal, they can be present as a block or they can be distributed over the polymer chain.

They can be linear or branched products. Such polymers are commercially available. Inventively suitable polybutadienes are liquid products having a molecular weight between 400 and 15 000 g/mol. They should preferably have an average functionality between 2.5 and 10.

Moreover, a suitable hydrophobic polyol can be selected from the oleochemical polyols. Oleochemical polyols are understood to mean polyols based on natural oils and fats, e.g. the reaction products of epoxidized fats with mono, di or polyfunctional alcohols or glycerine esters of long chain fatty acids, which are at least partially substituted with hydroxyl groups.

Such compounds are for example ring-opening products of epoxidized triglycerides, i.e. epoxidized fatty acid glycerine esters, in which the ring opening has been carried out to yield the ester bonds. A great number of epoxidized triglycerides of vegetal or animal origin can be used as starting materials for manufacturing the ring opening products. Thus, for example, epoxidized triglycerides containing 2 to 10 weight percent epoxide oxygen are suitable. These types of products can be manufactured by the epoxidation of the double bonds of a series of fats and oils, e.g. beef tallow, palm oil, peanut oil, rapeseed oil, cotton seed oil, soya oil, sunflower oil and linen oil.

Methanol, ethanol, propanol, isopropanol, butanol, hexanol, 2-ethylhexanol, fatty alcohols containing 6 to 22 carbon atoms, cyclohexanol, benzyl alcohol, 1,2-ethanol, 1,2-propane diol, 1,3-propane diol, 1,4-butane diol, 1,6-hexane diol, neopentyl glycol, trimethylolpropane, glycerine, trimethylolethane, pentaerythritol, sorbitol as well as ether group-containing hydroxy compounds such as alkyl glycols or oligomeric glycols as well as oligomeric glycerines can be employed as the alcohols for the ring opening of the epoxidized triglycerides.

The ring opening reaction of epoxidized fatty acid or triglyceride with an alcohol can optionally be followed by a transesterification with itself or with other, subsequently added triglycerides, such as for example palm oil, peanut oil, rapeseed oil, cotton seed oil, soya oil, sunflower oil and linen oil. Such oleochemical polyols are described for example in the German patent application DE 41 28 649.

Another group of oleochemical polyols are ring opening and transesterification products of epoxidized fatty acid esters of lower alcohols, i.e. of methyl, ethyl, propyl or butyl esters of epoxidized fatty acids. The ring opening or transesterification products with alcohols with a functionality of 2 to 4 are preferred, especially the transesterification products with ethylene glycol, propylene glycol, oligomeric ethylene glycols, oligomeric propylene glycols, glycerine, trimethylolpropane or pentaerythritol. Such products can be manufactured by known epoxidation processes or ring opening processes, wherein the transesterification can be carried out during or after the ring opening step by removing the lower alcohol from the reaction equilibrium. Ring opening and transesterification products are preferred, in which a molar ratio between epoxidized fatty acid ester and the alcohol used for transesterification was from 1:1 to 1:10.

Similarly to the oleochemical polyols, the transesterification products of epoxidized fatty alcohols with C₂-C₈ alcohols of a functionality 1 to 10, especially 2 to 4, comprise a molar ratio of epoxy groups to the hydroxyl groups of 1:1 to 1:10.

In the context of the invention, the use of oleochemical polyols that can be obtained from di or polyhydric alcohols such as e.g. the addition product of ethylene oxide or propylene oxide on glycerine with triglycerides such as palm oil, peanut oil, rapeseed oil, cotton seed oil, soya oil, sunflower oil and linen oil, is also possible

The use of castor oil or dimer diols that are manufactured by the total ring opening of epoxidized triglycerides of a fat mixture comprising at least partially olefinically unsaturated fatty acids with one or more alcohols having 1 to 12 carbon atoms and subsequent partial transesterification of the triglyceride derivatives to alkyl ester polyols is preferred. The polyols can have hydroxyl numbers of ca. 50 to 400, preferably 100 to 300. They should have a mean functionality of more than 2, in particular the functionality should be between ca. 2.5 and 5.

Hydrophobic polyethers are another class of hydrophobic polyols. Such polyethers are reaction products of polyhydroxy alcohols, for example aliphatic alcohols containing 2-4 hydroxyl groups per molecule. Primary and secondary alcohols can be employed. They are reacted, for example with alkylene oxides containing three or four carbon atoms. Suitable reaction products are those for example from ethylene glycol, propylene glycol, the isomeric butane diols or hexane diols, sugar alcohols, glycerine, trimethylolethane, trimethylolpropane, pentaerythritol with propylene oxide and/or especially butene oxide. Suitable polyols are also obtainable from the polymerization of tetrahydrofuran. Polyether polyols with a molecular weight of 300-15 000 g/mol, preferably 500-10 000 g/mol are particularly suitable.

Component A preferably comprises castor oil and/or OH-containing polybutadienes.

A further ingredient that is essential for the invention is one or more low molecular weight hydrophilic polyols that should have a molecular weight of less than 500 g/mol. Hydrophilic polyols are understood to mean those polar alcohols that possess a plurality of OH groups. Here, there should be present maximum 12 carbon atoms per OH group, especially less than or equal to 8 carbon atoms. For example, alkane diols containing 2 to 12 carbon atoms can be employed, especially with 3 to 8 carbon atoms, wherein the alcohol can be linear, branched or cyclic. Examples of such diols are 1,2-, 1,3-propane diol, 1,4-, 2,4-, 2,3-butane diol, neopentyl glycol, pentane diol, 1,6-hexane diol, 2-ethylhexane-1,3-diol, octane diol or further higher homologs. Another group of suitable diols are the low molecular weight polyalkylene glycols, such as polyethylene glycol, polypropylene glycol or corresponding mixed glycols. Such polyether diols can have a molecular weight between 150 and 500 g/mol for example. Trihydric or higher functional polyols can also be employed, for example glycerine, pentaerythritol, trimethylolpropane, trimethylolethane, or addition products of up to 10 mol ethylene oxide or propylene oxide on glycerine or sugar alcohols.

Such hydrophilic polyols should have a molecular weight of less than 500 g/mol, especially less than 300 g/mol. They are comprised in an amount of 0.1 to 15 wt. %, preferably from 0.5 to 10 wt. %, based on the component A. Mixtures of such polyols can also be employed. The reactivity of the mixture is influenced by the quantity of the hydrophilic polyols. The crosslinking density of the cured composition is similarly influenced. These low molecular weight polyols should be miscible with the hydrophobic polyols.

According to the invention, the polyol component A must comprise water-absorbing ingredients. So-called molecular sieves are suitable, thereunder are understood inorganic silicates, which are known to the person skilled in the art as zeolites. These are natural or synthetic porous materials that possess a great number of pores. The zeolites are often characterized by their pore size; according to the invention, values between 0.2 and 0.8 nm are preferred, especially 0.3 to 0.5 nm. The inventively employable molecular sieves should be in powder form, for example with a particle size below 0.5 mm, especially smaller than 100 μm, preferably between 0.5 and 30 μm. The quantity of the molecular sieve can range from 1 to 50 wt. %, preferably between 5 and 40 wt. %, in particular more than 10 wt. %, based on the component A. The quantity of the molecular sieve should be higher than the quantity of molecular sieve required for drying the polyols.

The inventive compositions should be able to cure to homogeneous polyurethane compounds. On account of this, additional components that can possibly lead to the formation of gases, such as CO₂, must be avoided. With this in mind, the inventive potting compound must be free, for example, of organic carboxylic acids.

The known paint or adhesive polyisocyanates can be employed as the component B. Polyisocyanates are understood to mean a compound containing two or more isocyanate groups. Suitable polyisocyanates are selected from the group 1,5-naphthalene diisocyanate, 2,4- or 4,4′-diphenylmethane diisocyanate (MDI), hydrogenated MDI (H₁₂MDI), xylene diisocyanate (XDI), tetramethylxylene diisocyanate (TMXDI), 4,4′-diphenyldimethylmethane diisocyanate, di- and tetraalkylene diphenylmethane diisocyanate, 4,4′-dibenzyl diisocyanate, 1,3-phenylene diisocyanate, 1,4-phenylene diisocyanate, toluene diisocyanate (TDI), 1-methyl-2,4-diisocyanato-cyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, cyclohexane-1,4-diisocyanate, ethylene-diisocyanate, methylenetriphenyl triisocyanate (MIT), phthalic acid bis-isocyanatoethyl ester, trimethylhexamethylene diisocyanate, 1,4-diisocyanatobutane, 1,12-diisocyanatododecane and dimerfafty acid diisocyanate. Polyisocyanates that result from the trimerization or oligomerization of diisocyanates are also suitable as the at least trifunctional isocyanates.

NCO-containing polyurethane prepolymers can also be employed as the NCO-reactive component. They should be liquid. They are reaction products of the isocyanates listed above with polyfunctional hydroxyl or amino group-containing compounds, especially diols. These can be, for example, low molecular weight reaction products of MDI or TDI with low molecular weight di to tetrahydric alcohols with a molecular weight of less than 300, such as e.g. ethylene glycol, diethylene glycol, glycerine, dimethylolpropane, propylene glycol, dipropylene glycol or triethylene glycol. However, diols based on polyethers, polyesters, polycarbonates, polylactones, polyacrylates or polyolefins can also be reacted. These types of prepolymers are known to the person skilled in the art and are also commercially available.

Aromatic polyisocyanates or isocyanate-functional prepolymers, in particular based on MDI, its isomers and its reaction products are preferred. The inventive 2K PU compositions can optionally also comprise the conventional additives comprised in PU adhesives or potting compounds. These can be for example catalysts, leveling agents, stabilizers, coupling agents, dyes, pigments or wetting agents. Such additives are known to the person skilled in the art and can be employed when needed. It should be noted that these additives, if possible, do not contain any NCO-reactive groups. In principle, the additives can be blended into both components, although they are usually mixed into the polyol component.

A particular embodiment of the invention consists in a composition comprising as the component A 30 to 80 wt. % of hydrophobic polyols, especially oleochemical polyols and/or OH-containing polybutadienes, 0.5 to 10 wt. % of low molecular weight hydrophilic polyols with a molecular weight of less than 500 g/mol, 5 to 40 wt. % of molecular sieve powder having a pore size of 0.3 to 0.5 nm and optional additives, wherein the sum of these ingredients should be 100%, and as the component B 15 to 60 parts by weight, based on the OH components, of aromatic diisocyanates and/or NCO-terminated PU prepolymers. The amounts of the component B are selected such that an NCO/OH ratio is obtained between 0.95 and 1.2.

Both components are mixed before the application. A good miscibility should be observed. If the chosen fraction of hydrophilic polyols is too high then the miscibility is reduced. The reactivity of the system can be influenced by the amount of the low molecular weight polyols. The crosslinking density can be adjusted by the amount of diols and/or triols. The potting compound preferably comprises only low amounts of less than 1 wt. %, preferably none, of amino group-containing ingredients. Directly after mixing, the inventive 2K PU composition should have a viscosity between 200 and 5000 mPas at the processing temperature, especially between 400 and 2500 mPas (measured according to Brookfield, EN ISO 2555, at the specified temperature). The composition should preferably have a suitable viscosity between 20 to 35° C.

During the crosslinking reaction the resulting crosslinking temperature should be less than 150° C., preferably less than 120° C., especially less than 100° C. (measured with a 200 g quantity of mixture, blended at room temperature). If the chosen reactivity is too high, then the compound heats up too strongly and damage can appear on the parts being adhesively bonded.

Another subject matter of the invention is a process for adhesively bonding membranes with an inventive adhesive. Here, the manufactured membrane is treated as a surface or especially as hollow fibers directly after the manufacturing process. The still moist hollow fiber surfaces containing water or protic solvent are converted into the desired shape without further drying steps. The surface can comprise for example water, alcohols, low molecular weight amines or carboxylic acids from its manufacture. The fibers can have been provided with an external, removable coating; also additional parts can optionally be attached as a permanently adherable external coating. The molded articles that were preformed in this way are then encapsulated with the liquid mixed 2K PU composition at the locations intended to hold together the bundle of hollow fibers, and after curing there results a solid, dimensionally stable non-tacky molded article. Optionally, flat substrates can also be adhesively bonded together in a similar way.

Another embodiment of the invention is a process for adhesively bonding natural or synthetic fibers. These are stable fibers that can be hollow or they consist wholly of the fiber material. The fibers can be cleaned although it is not necessary for them to be dried or otherwise pre-treated. In the inventive technique these moist fibers can then be arranged as desired and be inserted, optionally under pressure, into an external mold. The shape of the tooling is determined by the casing. In the inventive technique the cavity between the fibers is filled up with the inventive 2K composition.

The composition should firmly encapsulate the hollow fiber bundle to be adhesively bonded, i.e. the composition should not form any cavities or bubbles. This can be achieved by means of a suitable viscosity; this should be between 200 and 5000 mPas at the process temperature. It is possible to increase the temperature of the mixture in order to obtain a low viscosity; however it is preferred to work between 20 and 35° C. It is also possible to apply the compound under increased pressure onto the adhesion locations, or to ensure a good flow of the composition into the cavities by mechanical movement of the coating, e.g. by centrifugation. The viscosity should be selected as a function of the substrate to be adhesively bonded such that the liquid composition does not pass through the membranes to be adhesively bonded, for example through the pores.

The molded article formed in this way can then be cured. The curing rate can be influenced by adding catalyst or by increasing the temperature. If too high a temperature is chosen, the membrane to be adhesively bonded could possibly be damaged. The self-reaction of the composition should not cause the temperature to rise above 120° C., preferably not over 100° C.; an optional cooling is possible. The molded object can then be optionally removed from the casing or it is permanently adhesively bonded to the external cladding. A molded article is then obtained that permanently embeds the membrane parts. By the inventive technique, one can avoid the formation of bubbles, cavities or other defects in the adhesive surface or potting surface. The resulting crosslinked molded articles are also well crosslinked on the surface to the adhesively bonded substrates and demonstrate a good, water-resistant adhesion behavior. Even the conditions of a subsequent sterilization by moisture, heat and pressure do not lead to a destruction of the potted part.

The inventive molded parts made of fibers are very stable. In the case of fibers that have polar groups on the surface, for example glass fibers or organic fibers, the adhesion of the 2K composition to the fiber parts is very high. The fibers are permanently embedded in the crosslinked adhesive matrix and have a good adhesion to the adhesive.

A further advantage of the inventive use of the 2K PU composition is that by choosing suitable raw materials, molded articles are obtained that possibly meet the use requirements in the food or medical areas. The compounds are crosslinked and there are essentially no migratable ingredients present. A fast additional treatment of the molded article is enabled. The molded articles are particularly suitable for use as membrane modules in the treatment of liquids, e.g. in water treatment, in the treatment of liquids for medicinal purposes or in the food industry. Many other substrates can also be permanently adhesively bonded or encapsulated.

The invention is illustrated by means of the following examples.

### EXAMPLES

### Example 1

| | | |
|---|---|---|
| Castor oil (functionality 2.8) | 50 | wt. % |
| PPG Triol (Mₙ 250) | 4 | wt. % |
| SiO₂ (Aerosil) | 0.2 | wt. % |
| Molecular sieve (3 A) | 45.8 | wt. % |

| | |
|---|---|
| Polymeric MDI | 20 parts by wt. |
| | NCO/OH-ratio 0.95 |
| | (30-33% NCO) |

### Example 2

| | | |
|---|---|---|
| Castor oil (functionality 2.8) | 70 | wt. % |
| PPG Triol (Mₙ 250) | 4.8 | wt. % |
| 1,4-Butane diol | 5 | wt. % |
| SiO₂ (Aerosil) | 0.2 | wt. % |
| Molecular sieve (3 A) | 20 | wt. % |

| | |
|---|---|
| Polymeric MDI | 47 parts by wt. |
| | NCO/OH-ratio 1.05 |

### Example 3

| | | |
|---|---|---|
| Castor oil (functionality 2.8) | 10 | wt. % |
| OH-terminated polybutadiene (OH number 80) | 45 | wt. % |
| PPG Triol (Mₙ 250) | 2 | wt. % |
| 1,4-Butane diol | 5 | wt. % |
| Molecular sieve (3 A) | 38 | wt. % |

| | |
|---|---|
| Polymeric MDI | 33 parts by weight |
| | NCO/OH-ratio 1.15 |

### Example 4

Commercial polymer fibers based on sulfone were dipped into a 50% glycerine solution with water. The fibers were removed, drained and adhesively bonded with an inventive casting resin, directly after having mixed both of the components, to form a fiber bundle. A catalyst was not added.

After two hours the hollow fibers were adhesively bonded together such that they can be optionally further processed.

The Shore-A hardness was 30.
(measured as the compound without fibers from 200 g mixture)
The cast, molded articles are hard and are exempt from bubbles.

### Comparative Example

| | | |
|---|---|---|
| Castor oil (functionality 2.8) | 70 | wt. % |
| PPG Triol (Mₙ 250) | 4.7 | wt. % |
| 1,4-Butane diol | 5 | wt. % |
| SiO₂ (Aerosil) | 0.3 | wt. % |

| | |
|---|---|
| Polymeric MDI | 37.5 parts by wt. |

The compound was similarly processed. One molded article showed the formation of bubbles; moreover the hollow fibers were not solidly embedded.

1. A crosslinkable, liquid 2K polyurethane composition comprising:
a) component A which comprises a mixture of (i) at least one hydrophobic polyol with a molecular weight greater than 300 g/mol, (ii) at least one low molecular weight hydrophilic polyol with a molecular weight lower than 500 g/mol, and (iii) 1 to 50 wt. %, based on component A, of a powdered molecular sieves; and
b) component B which comprises at least one polyisocyanate and/or an NCO-reactive polyurethane prepolymer.

2. The 2K polyurethane composition according to claim 1, wherein the hydrophobic polyol is selected from the oleo chemical polyols, OH-containing polybutadienes with a molecular weight greater than 500 g/mol or mixtures thereof.

3. The 2K polyurethane composition according to claim 1, wherein (iii) of the component A comprises 5 to 40 wt. % of the powdered molecular sieves with a particle size between 0.5 to 100 μm.

4. The 2K polyurethane composition according to claim 1, wherein the low molecular weight hydrophilic polyol is a hydric polyol having three to six —OH groups with a molecular weight below 300 g/mol.

5. The 2K polyurethane composition according to claim 1, wherein the component B is an aromatic isocyanate and/or a corresponding isocyanate-reactive polyurethane prepolymer.

6. The 2K polyurethane composition according to claim 1, in which no aminofunctional group is present.

7. The 2K polyurethane composition according to claim 1, further comprising a catalyst.

8. The 2K polyurethane composition according to claim 1, wherein the composition has a viscosity between 200 and 5000 mPas at the application temperature.

9. The 2K polyurethane composition according to claim 1, wherein the component A comprises 30 to 80 wt. % hydrophobic polyols, 0.5 to 10 wt. % low molecular weight hydrophilic polyols, 5 to 40 wt. % molecular sieve powder, and up to 7.5 wt. % low molecular diols, wherein the sum equals to 100%.

10. A process for gluing a plastic, metallic fibers or membranes comprising:
a) delivering the plastic, the metallic fibers or the membranes to an external mold,
b) applying the liquid 2K polyurethane composition of claim 1 between the parts to be glued, and
c) curing the liquid 2K polyurethane composition at a temperature below 150° C.

11. The process according to claim 10, wherein the metallic fibers are natural or synthetic polymers.

12. The process according to claim 11, wherein the metallic fibers are hollow fibers with polymeric membrane surfaces.

13. The process according to claim 12, wherein the fibers are cleaned or treated with a H-acidic solvent before delivering them to the external mold and without drying them.

14. The process according to claim 10, wherein the external mold is removed after curing.

15. The process according to claim 10, further comprising a sterilization step.

16. A molded object comprising the 2K polyurethane composition of claim 1.
